(19) United States
(12) Patent Application Publication
(10) Pub. No.: US 2026/0172568 A1
(43) Pub. Date: Jun. 18, 2026

(54) SYSTEMS AND METHODS FOR DYNAMICALLY ADJUSTING PICTURE RESOLUTION IN VIDEO ENCODED FOR STREAMING IN RESPONSE TO CHANGES IN ESTIMATED BANDWIDTH

(71) Applicant: Adeia Guides Inc., San Jose, CA (US)

(72) Inventors: Tao Chen, Palo Alto, CA (US); Ning Xu, Irvine, CA (US)

(21) Appl. No.: 18/978,531

(22) Filed: Dec. 12, 2024

(51) Int. Cl. H04N 19/132; H04N 19/146; H04N 19/164; H04N 19/172; H04N 19/192

(52) U.S. Cl. CPC H04N 19/132; H04N 19/146; H04N 19/164; H04N 19/172; H04N 19/192

(57) ABSTRACT

Systems and methods are provided for dynamically adjusting picture resolution in streaming video in response to estimated bandwidth changes in the network connection. During encoding of a first video segment of a source video, a change in the estimated bandwidth may be detected. To account for changes in the estimated bandwidth, first image frame quality data based on first segment image frames in the first video segment and second image frame quality data based on a subsequent image frame in a second video segment of the source video are generated. The bitrate and picture resolution for the second video segment are determined based on the change in the estimated bandwidth and a comparison of the first image frame quality data with the second image frame quality data. The second video segment may then be encoded for streaming at the bitrate and picture resolution determined by the comparison.

### BACKGROUND

This disclosure is related to adjusting picture resolution in streaming video, and more particularly to systems and methods for dynamically changing picture resolution in video encoded for streaming in response to changes in estimated bandwidth.

### SUMMARY

Network bandwidth fluctuations are common during video streaming, and the estimated bandwidth of the network connection between a streaming server and a recipient device may significantly impact the viewing experience at the recipient device. How these fluctuations are handled by video streaming servers to maintain viewability quality of the streaming video on the recipient device often depends on one or both of the video codec used to encode the video and the process used to stream the video. Typically, a reduction in estimated bandwidth leads to the streaming server streaming video at a lower bitrate in order to continue streaming at the lower bandwidth. This reduction in bitrate may also result in a reduction in picture resolution for the streamed video. With a reduction in bitrate, the viewer on the device receiving the streaming video often ends up with a poorer viewing experience. In some circumstances, the viewing experience may also be negatively impacted by the picture resolution selected for streaming the video.

For videos that are produced sufficiently in advance of streaming, a common solution is to employ available computing resources to encode the source video at several different bitrates before making the video available for streaming. One solution that provides offline processing of source videos in preparation for streaming creates an adaptive bitrate (ABR) ladder, which is a set of encoded videos, all based on the original source video, with each encoded video having a pre-determined bitrate and picture resolution. One advantage of creating an ABR ladder is that a computing system may use multi-pass encoding to generate the set of encoded videos for streaming. Once generated, the set of encoded videos are saved to storage for access when a request for streaming the video is made by a recipient device. An example of an ABR ladder may include several encoded versions of the source video: a high bitrate encoding at a high resolution (e.g., 1080p), a medium bitrate encoding at a medium resolution (e.g., 720p), and a low bitrate encoding at a low resolution (e.g., 480p).

During video streaming to a recipient device using this example ABR ladder, the streaming server may start communicating the video stream with the high bitrate encoded, high picture resolution version of the source video to the recipient device, and upon determining that there is a reduction in the estimated bandwidth, the streaming server may switch to the medium bitrate encoded, medium picture resolution version of the source video. This switch, based on the example ABR ladder, may result in a reduction in the picture resolution of the streamed video because the offline encoded bitstreams for the ABR ladder do not include a medium bitrate bitstream at a high picture resolution. Such a reduction in picture resolution may, depending on the recipient device, result in reduction in quality of the video displayed on the recipient device.

As shown by this example, when prior generated source videos are streamed and can be processed offline prior to streaming, streaming servers are limited to streaming versions of the source video that were previously encoded. While this offline processing provides multiple versions of the source video for streaming at different bandwidths, one downside of processing source videos offline before streaming is that for some estimated bandwidth reductions, an encoded version of the source video may not exist to account for a wide array of bandwidth conditions. Thus, a low bitrate encoded, low resolution version of the source video may be streamed to a recipient device with a large screen (e.g., a smart TV) when the bandwidth may be capable of supporting streaming of a low bitrate encoded, medium or high-resolution version of the source video that would provide a higher quality viewing experience on the recipient device. The ABR ladder and other similar offline encoding processes, therefore, may at times deliver less than optimal streaming video to a recipient device.

Streaming low-latency videos or interactive videos, both of which typically are generated with single-pass encoding, presents different challenges when reductions in estimated bandwidth occur. When streaming videos under such circumstances, the streaming server (which, in some instances, may be a user device such as a laptop computer, a tablet computer, a smart phone, etc.) has no opportunity to generate versions of the source video for an ABR ladder due to the short time frame (in some environments, the delay may be 50 milliseconds or less) between the time the source video is generated and the time the encoded video is streamed to a recipient device. In these streaming conditions, when a reduction in estimated bandwidth is detected, streaming servers typically encode the source video with a lower bitrate to account for reduced estimated bandwidth and reduce the picture resolution to maintain the low-latency or interactive video streaming.

A need therefore exists to enable streaming servers to improve the streaming video viewing experience on the recipient device when a reduction in estimated bandwidth occurs. To address this need and overcome the shortcomings introduced by existing video streaming systems that do not account for picture resolution when making adjustments to bitrate in response to reductions in estimated bandwidth, systems and methods that dynamically adjust both the bitrate and the picture resolution are disclosed herein. These systems and methods may be used advantageously for streaming video that is generated well in advance of streaming requests and for streaming video that is generated for low-latency and/or interactive streaming. In all instances, both the bitrate and the picture resolution may be dynamically adjusted in response to changes in estimated bandwidth.

In some embodiments, following initiation of a streaming video to a recipient device, the streaming server may begin streaming by encoding image frames of the source video with a picture resolution based on the estimated bandwidth at the time streaming is initiated. After encoding, the streaming server streams encoded image frames to the recipient device and generates image frame quality data based on one or more of the source video image frames and the encoded image frames. Upon detection of a change in the estimated bandwidth (the change may be detected by the streaming server, through feedback from a recipient device or other devices, or through data collected to establish quality of experience parameters), the streaming server generates image frame quality data for a subsequent image frame of the source video to be encoded and streamed. The streaming server determines the encoded bitrate for the subsequent image frame based on the detected change for the estimated bandwidth, and the streaming server determines the picture resolution based on a comparison between the image frame quality data based on the previously encoded and streamed image frames with the image frame quality data based on the subsequent image frame. This comparison of image frame quality data enables the streaming server to select a picture resolution that is optimized for display of the streaming video on a recipient device.

In some embodiments, the streaming server may perform the comparison between the image frame quality data based on the previously encoded and streamed image frames with the image frame quality data based on the subsequent image frame using nonparametric statistical analysis. In such embodiments, the comparison may be performed using a predetermined mathematical model with weights assigned to different factors included as part of the analysis model. In some embodiments, the streaming server may perform the comparison between the image frame quality data based on the previously encoded and streamed image frames with the image frame quality data based on the subsequent image frame using machine learning models. In such embodiments, the comparison may be performed using any one or combination of machine learning models, including models such as a convolutional neural network model, a multiple layer perceptron model, and a recurrent neural network, among others. In some embodiments, the image frame quality data based on the previously encoded and streamed image frames may include a comparison between the source video image frames and one or more of encoded image frames, resampled image frames, and resampled and encoded image frames. In some embodiments, the image frame quality data based on the subsequent image frame may include a comparison between the subsequent image frame and multiple versions of the subsequent image frame resampled at different picture resolutions.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale. The figures include:

FIG. 1 schematically illustrates an exemplary process for dynamically adjusting picture resolution in streaming video in response to changes in estimated bandwidth, in accordance with embodiments of the disclosure;

FIG. 2 is a flowchart showing an exemplary process for dynamically adjusting picture resolution in streaming video in response to changes in estimated bandwidth, in accordance with embodiments of the disclosure;

FIG. 3 schematically illustrates exemplary image frame quality data generated for dynamically determining adjustments to picture resolution in streaming video, in accordance with some embodiments of this disclosure;

FIG. 4 is a diagram illustrating a first machine learning model for use in processes for dynamically adjusting picture resolution in streaming video, in accordance with embodiments of the disclosure;

FIG. 5 is a diagram illustrating a second machine learning model for use in processes for dynamically adjusting picture resolution in streaming video, in accordance with embodiments of the disclosure;

FIG. 6 is a flowchart showing an exemplary process for resetting image frame quality data for encoded and streamed image frames in response to a change associated with the source video, in accordance with embodiments of the disclosure;

FIG. 7 is a flowchart showing an exemplary process for incorporating feedback from a recipient device into picture resolution determinations for streaming video, in accordance with embodiments of the disclosure;

FIG. 8 illustrates an exemplary system for streaming video over a network to one or more recipient devices, in accordance with embodiments of the disclosure; and

FIG. 9 illustrates exemplary recipient devices for receiving streaming video over a network from a streaming video server.

### DETAILED DESCRIPTION

Systems and methods are described herein for dynamically adjusting picture resolution of streamed video in response to changes in estimated bandwidth. The systems and methods may be used to improve the visual quality of streamed video on a recipient device due to changes in encoding bitrate that may be necessitated by changes in the estimated bandwidth of the network connection between the streaming server and the recipient device. Advantageously, the systems and methods may be used to improve the user experience for low-latency and/or interactive video streaming and in other video streaming environments where single-pass encoding is utilized. The systems and methods may also be used to improve the visual quality of streamed video in streaming environments to enhance the use of ABR ladders.

As described herein, the term “user device” and “recipient device”, and variants thereof, refer to any electronic device with which a person, the user, may interact with to send and/or receive streaming video. Variants of the terms “user device” and/or “recipient device” may be used to differentiate between different devices for purposes of this disclosure, even though the devices may otherwise be of identical construction. The use of a variant is not intended to indicate any differences between devices unless such differences are expressly indicated herein.

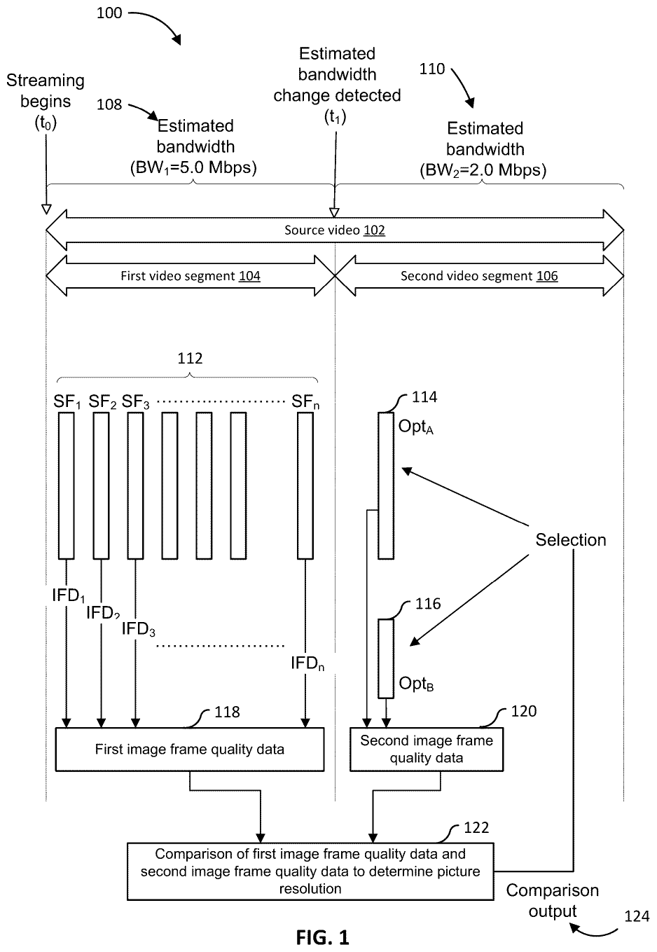

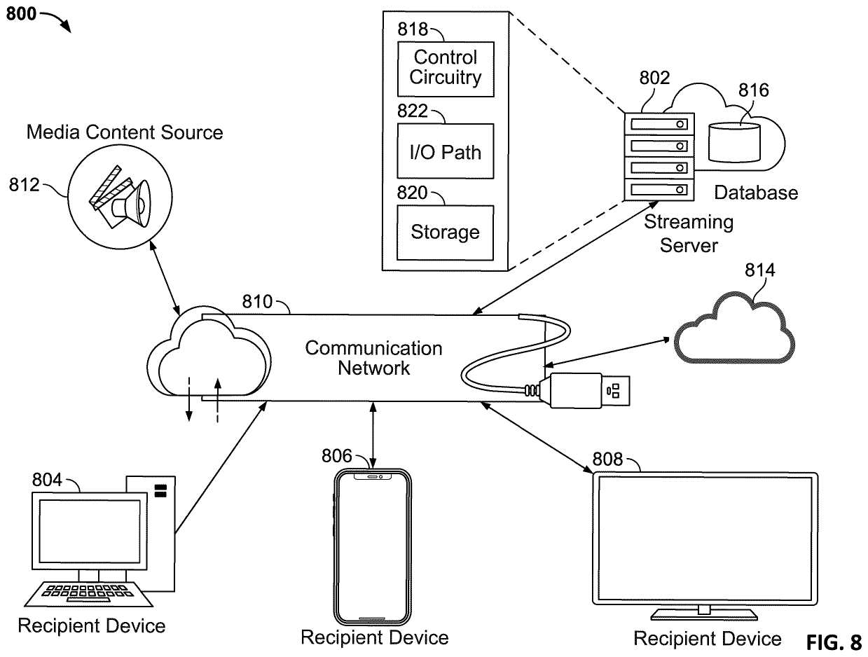

Turning in detail to the drawings, FIG. 1 illustrates a process 100 for dynamically adjusting picture resolution in streaming video in response to changes in estimated bandwidth. The source video 102 in this process may be generated at a streaming server (e.g., the streaming server 802 of FIG. 8) and streamed to a recipient device (e.g., any one or more of the recipient devices 804, 806, 808 of FIG. 8). In some embodiments, the streaming server may be a user device such as a smart phone, a tablet computer, a laptop computer, a desktop computer, a smart TV, and the like, which streams video to another such user device. The source video 102 may be a previously generated video that is streamed on demand (e.g., a movie, a tv show, a podcast, and other similar types of video), a video bitstream that is generated immediately prior to the time of streaming (e.g., a video conference), or an interactive video that includes segments that change in response to interactions of a user at the recipient device.

As shown, the source video 102 includes a first video segment 104 and a second video segment 106. The source video 102 is shown with only two video segments 104, 106 for purposes of clarity. In some embodiments, the source video 102 may include additional video segments without limitation. For purposes of this process 100, the first video segment 104 begins at time t₀, and ends at time t₁. In some embodiments, the first video segment 104 may not be at the start of the source video 102, instead starting at some point in the middle of the source video 102. Regardless of where the first video segment 104 starts within the source video 102, the process 100 may still designate the start of the first video segment 104 as to. Between time t₀ and time t₁, the network connection has a first estimated bandwidth (labeled BW₁) 108, which for purposes of this exemplary process is 5 Mbps (megabits per second). At time t₁, the network connection has a second estimated bandwidth (labeled BW₂) 110, which for purposes of this exemplary process is 3 Mbps. Both bandwidths BW₁ and BW₂ in this process 100 are assigned exemplary bandwidth values as part of this description for purposes of clarity only. During execution of the process 100, a number of different factors may contribute to the available bandwidth over the network connection, such as the number and type of different communications paths between the streaming server and the recipient device and the load of other digital traffic transmitted on the network at the time the streaming video is being communicated to the recipient device. As such, the exemplary estimated bandwidth values shown are intended to be non-limiting.

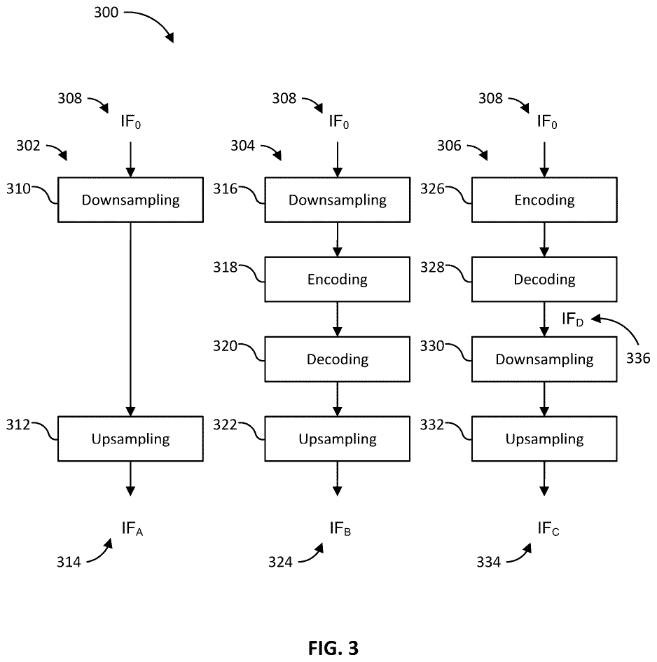

The first video segment 104 includes multiple encoded image frames (labeled SF₁₋ₙ) 112 that are streamed from the streaming server to the recipient device between to and t₁. The second video segment 106 starts at time t₁ and immediately follows the first video segment 104 within the source video 102. Although the second video segment 106 may also include multiple image frames for encoding, none of the encoded image frames for the second video segment 106 are shown in FIG. 1. Instead, following time t₁, two options for encoding the subsequent image frame are generated and analyzed. The subsequent image frame is the next image frame of the second video segment 106 to be streamed following a determination that the bitrate and/or the picture resolution of the encoded image frames should be dynamically adjusted. For purposes of this process 100, the subsequent image frame is the first image frame following time t₁, which is the time at which a change is detected in the estimated bandwidth. Two representative options for resampling and encoding the subsequent image frame are shown. As discussed in greater detail below in connection with FIGS. 3-5, these representative options 114, 116 are used by the process to evaluate the picture resolution for the subsequent image frame when encoded for streaming. The first representative option (labeled Opt_{A}) 114 is the subsequent image frame without resampling, such that the first representative option 114 has a picture resolution that is the same as the picture resolution of the encoded image frames 112. The second representative option (labeled Opt_{B}) 116 is the subsequent image frame resampled at a picture resolution that is lower than the picture resolution of the encoded image frames 112. In this exemplary process 100, since the second estimated bandwidth 110 is less than the first estimated bandwidth 108, the process 100 would set the bitrate for encoding image frames of the second video segment 106 at less than the bitrate of the encoded image frames 112. In some embodiments, the second estimated bandwidth 110 may be greater than the first estimated bandwidth, and in such embodiments the process 100 may be used to dynamically increase the picture resolution and/or bitrate of the streamed video following detection of the change in estimated bandwidth.

In some embodiments, the process 100 may generate more than two representative options for resampling and encoding the subsequent image frame. The picture resolutions included in the representative options 114, 116 may be predetermined from a set of standardized picture resolutions (e.g., the following may be used as a set of standardized picture resolutions: 1080p, 720p, 480p, and 360p). In some embodiments, the representative options 114, 116 may include the picture resolution of the encoded and streamed image frames 112 (e.g., 1080p) of the first video segment 104 and the next lower picture resolution selected from a set of standardized picture resolutions (e.g., 720p). In some embodiments, the representative options may include the picture resolution of the encoded and streamed image frames 112 of the first video segment 104 and the next two lower picture resolutions selected from a set of standardized picture resolutions.

While image frames from the first video segment 104 are streamed, the process 100 generates image frame quality data 118 (labeled IFD_{1-N}) for one or more of the encoded and streamed image frames 112. The image frame quality data 118 is reference data that may be used to evaluate the impact of resampling and/or encoding on the quality of the streaming video. As discussed in further detail below, image frame quality data 118 may be generated by comparing an image frame from the source video 102 with the associated resampled and/or encoded image frame as prepared for streaming. In some embodiments, image frame quality data 118 may be generated for every encoded and streamed image frame 112 in the first video segment 104. In some embodiments, image frame quality data 118 may be generated for fewer than all the encoded and streamed image frames 112 in the first video segment 104. The image frame quality data 118 may be generated for encoded and streamed image frames 112 concurrently with encoding of each respective image frame for streaming. In some embodiments, the image frame quality data 118 may be generated in post processing after an image frame has been encoded and streamed.

Once the change in estimated bandwidth has been detected at t₁, the process 100 generates image frame quality data 120 for each of the representative options 114, 116 for the subsequent image frame. This image frame quality data 120 may be generated by resampling the subsequent image frame from the source video 102 based on one of the representative options 114, 116. In some embodiments, the image frame quality data 120 may be generated by comparing the image frame from the source video 102 with each representative option 114, 116. Exemplary techniques for preforming this comparison are discussed in greater detail below.

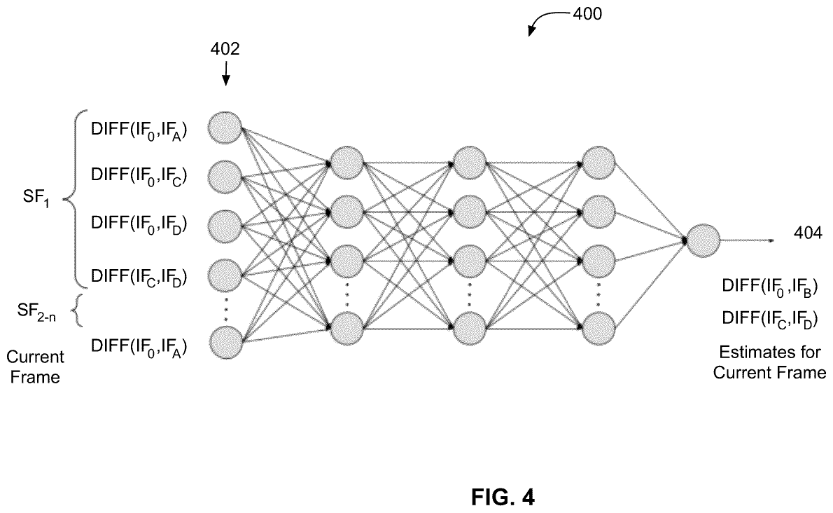

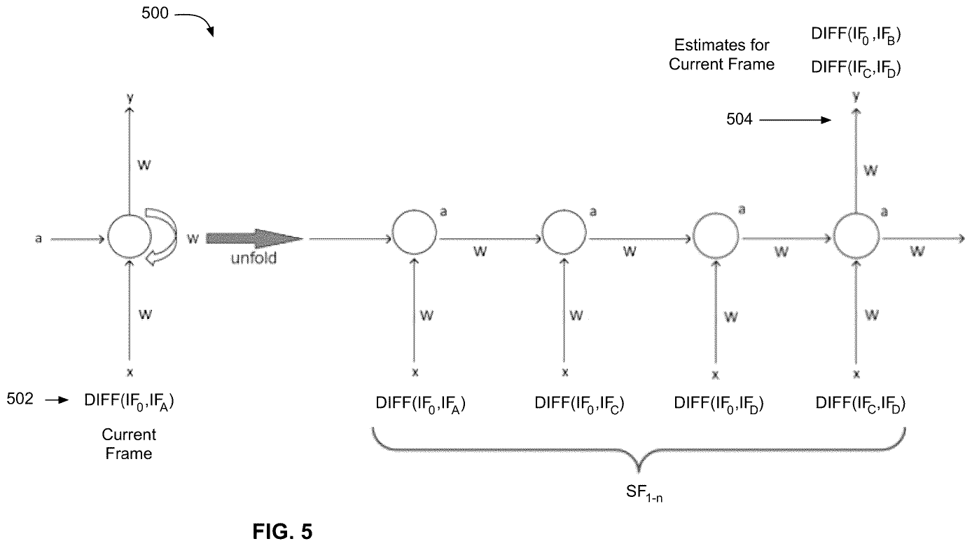

With the image frame quality data 118 for the encoded and streamed image frames 112 and the image frame quality data 120 for the representative options 114, 116 having been generated, both sets of image frame quality data 118, 120 may be directed to a comparison sub-process 122. The purpose of the comparison is to evaluate whether the subsequent image frame, when encoded at an appropriate bitrate for the second estimated bandwidth 110, would present a better picture quality on the recipient device if streamed at the picture resolution of the first representative option 114 or if streamed at the picture resolution of the second representative option 116. This comparison may be performed using different techniques, three of which are discussed below: a non-parametric statistical analysis (FIG. 3); a multiple layer perceptron machine learning model (FIG. 4); or a recurrent neural network machine learning model (FIG. 5). The output 124 from the comparison sub-process 122 identifies the picture resolution the process 100 should use for streaming the subsequent image frame (and other image frames) in the second video segment 106. After the bitrate and picture resolution of the streaming video has been dynamically adjusted at time t₁ due to the detected change represented by the second estimated bandwidth 110, in some embodiments the process 100 may reset the time markers, such that time t₀ now marks the beginning of the second video segment 106, and reset the image frame quality data 118 to remove data relating to the first video segment 104. The process 100 may then begin generating image frame quality data relating to image frames encoded and streamed from the second video segment 106. In some embodiments, the process 100 may keep the image frame quality data relating to the first video segment 104, as that data may continue to be useful for determining further dynamic changes to the picture resolution for streaming the source video 102.

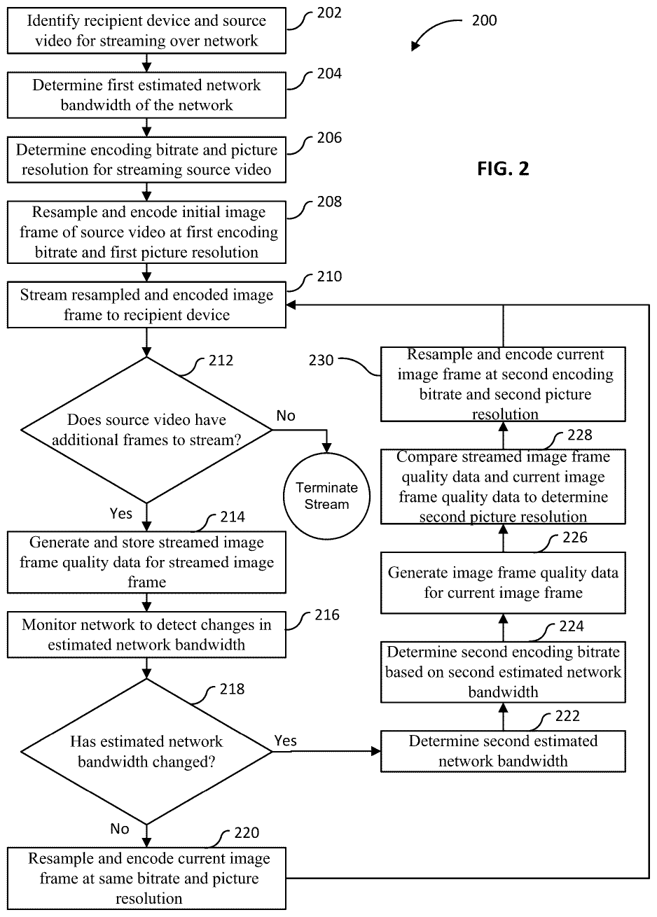

FIG. 2 is a flowchart illustrating the steps of an exemplary process 200 for dynamically adjusting the picture resolution in streaming video in response to changes in estimated bandwidth of the network connection. The process 200 may be implemented on systems that are used for streaming video as discussed herein. One or more actions of the process 200 may be incorporated into or combined with one or more actions of any other process or embodiment described herein. For purposes of clarity, this process 200 is described in the context of being implemented on the streaming server 802 shown in FIG. 8. Also, any of the user devices 804, 806, 808 may perform the actions of process 200 when operated to stream video to a recipient device. In addition, one or more steps of the process 200 may be executed using distributed computing techniques, such that steps of the process 200 may be executed by control circuitry incorporated into other servers, cloud services, and/or other computing devices.

At step 202, the streaming server initiates and/or receives a request from a recipient device to begin streaming a source video over a network. In some embodiments, the network may be a public network, a private network, or combination of a public and private network. At step 204, the streaming server determines the first estimated bandwidth, and the first estimated bandwidth is used at step 206 to determine the first encoding bitrate and the first picture resolution for initiating streaming of the source video. In some embodiments, step 204 may be skipped over if the recipient device requests the video stream at a specified bitrate. In some embodiments, depending upon the picture resolution of the source video as generated, the first picture resolution may be determined to be the same as the picture resolution of the source video as generated. In such embodiments, the process may not need to perform resampling of the image frames in the first segment of the source video prior to encoding and streaming. At step 208, the streaming server resamples and encodes, as appropriate, the image frames of the source video at the determined first picture resolution and the first encoding bitrate. The image frames streamed at the first the picture resolution and first encoding bitrate form part of the first video segment of the source video in this process 200. At step 210, the streaming server streams the resampled and encoded image frames to the recipient device. At step 212, the process 200 determines if the source video includes additional image frames for streaming. If the source video does have additional image frames for streaming, at step 214 the process 200 generates and stores image frame quality data for the image frame last streamed at step 210. If the source video does not include any further image frames for streaming, the process 200 terminates.

At step 216, the process 200 monitors the network connection to detect changes in estimated bandwidth that would impact the quality of the network connection between the streaming server and the recipient device. In some embodiments, the process 200 may directly monitor the estimated bandwidth using data packets received from the recipient device that indicate receipt of the streaming video. In some embodiments, the process 200 may indirectly monitor the estimated bandwidth by relying on other devices, such as the recipient device, to provide feedback that indicates the timing and/or quality of the streaming video upon receipt. For example, the recipient device may provide feedback that indicates the timing between receipt of data packets of the streaming video, with delays in the timing providing an estimate of bandwidth. In some embodiments, the process 200 may utilize other methods for directly and/or indirectly monitoring the estimated bandwidth.

At step 218, the process 200 determines if the estimated bandwidth has changed. If no change has been detected, at step 220 the process 200 resamples and encodes, as appropriate, the subsequent image frame of the source video at the same bitrate and picture resolution that was used in step 208. The process then returns to step 210 to stream the resampled and encoded image frame to the recipient device. If the process 200 detects a change in the estimated bandwidth, at step 222 the process 200 determines the second estimated bandwidth. At step 224, the process 200 determines the second encoding bitrate based on the second estimated bandwidth. As with the initial estimated bandwidth, the second estimated bandwidth may be determined directly or indirectly by the process 200. At step 226, the process 200 generates image frame quality data for the subsequent image frame (i.e., the first image frame from the second video segment that is to be streamed). At step 228, the image frame quality data generated in step 214 from encoded and streamed image frames is compared with the image frame quality data generated in step 226 for the subsequent image frame. The comparison in step 228 is used to determine the second picture resolution for streaming the subsequent image frame and further subsequent image frames in the second video segment. Some exemplary techniques for making this comparison are discussed in greater detail below. At step 230, the subsequent image frame is resampled and encoded at the second picture resolution and the second encoding bitrate. Once the subsequent image frame is resampled and encoded, the process 200 returns to step 210 where the resampled and encoded subsequent image frame is streamed.

FIG. 3 graphically illustrates an exemplary process 300 for generating image frame quality data as part of making dynamic adjustments to picture resolution in streaming video. The process 300 shows three processing routines 302, 304, 306 that may be used for estimating picture quality and dynamically adjusting picture resolution in streaming video when a change is detected in the estimated bandwidth. Specifically, a first pair of the processing routines 302, 306 provide output that aids in generating image frame quality data for encoded and streamed image frames, while a second pair of the processing routines 304, 306 have outputs that are representative of the image quality that may be displayed on a recipient device following streaming of the subsequent image frame. To dynamically adjust the picture resolution of streaming video when changes in the estimated bandwidth occur, the image frame quality data generated from the first pair of the processing routines 302, 306 is used to estimate the representative outputs of the second pair of the processing routines 304, 306. Each representative output from the processing routines 304, 306 provides an adjustment option to the streaming server for dynamically selecting the picture resolution for the subsequent image frame (and following image frames), thereby improving the quality of the video viewed on the recipient device. The first adjustment option, based on the processing routine 304, is to resample image frames at a lower picture resolution and encode the resampled image frames at a lower bitrate. The second adjustment option, based on the processing routine 306, is to make no changes to the picture resolution and encode the image frames at a lower bitrate. However, since calculating the first and second adjustment options while streaming low-latency video requires substantial processing capabilities performed in a very short period of time, the streaming server may instead use the processing routines 302, 304, 306 to generate the representative options 114, 116 of FIG. 1 and identify the picture resolution that is determined to provide the best picture quality for the encoded and streamed video on a recipient device.

In some embodiments, additional processing routines may be added to the process 300 to enable consideration of additional adjustment options. For example, in some circumstances it may be desirable to include a processing routine to aid in estimating a third adjustment option, which may be to resample the image frames at yet a lower picture resolution and encode the image frames at a lower bitrate as compared to the other processing routines. In other embodiments in which the streaming video is downsampled and encoded to a target picture resolution for streaming, the processing routines may be used to compare a first adjustment option that compares a first adjustment option of downsampling the image frames to a lower picture resolution (as compared to the target picture resolution) and encoding at a lower bitrate with a second adjustment option of downsampling to the target picture resolution and encoding at the same lower bitrate. In some embodiments, the processing routines 302, 304, 306 may be altered to account for needs arising from the video streaming environment.

A comparison of image frame quality data from encoded and streamed image frames, when generated through processing routines 302, 306, in combination with image frame quality data generated through the processing routine 302 for the subsequent image frame, can provide an estimate of how encoding affects the picture quality presented on a recipient device both when no change is made to the picture resolution and when resampling is utilized. The input to each processing routine 302, 304, 306 is an image frame (labeled IF₀) 308 from the source video. The first processing routine 302 processes the image frame 308 at the input using a downsampling step 310 followed by an upsampling step 312. The downsampling step 310 downsamples the image frame 308 to a target picture resolution, and the upsampling step 312 upsamples the output of the downsampling step 310 to the original picture resolution of the image frame 308. The result of the first processing routine 302 is a first processed image frame (labeled IF_{A}) 314. From this processing routine 302, the image frame 308 and the first processed image frame 314 may be compared for overall similarities or differences using image comparison tools, statistical analysis, and/or machine learning models.

In some embodiments, a structural similarity index measure (SSIM) may be used to measure the perceived picture quality similarity between an original image and a processed version of the original image through an analysis of structural similarities between the two images. Through use of SSIM, the comparison process returns a numerical value to indicate the perceived picture quality similarity between the two images, with a value of 1.0 denoting no perceived difference. SSIM, therefore, is useful for the image comparisons discussed herein because the return of a numerical value enables the SSIM determination to be incorporated into a nonparametric statistical analysis.

In some embodiments, an image difference function (typically referred to as the “diff function”), which returns an image showing a pixel-by-pixel difference between the original image and the compared image, may also be used to determine the differences between the image frame 308 and the first processed image frame 314. However, because an image difference function effectively returns a matrix, the statistical analysis may be more complex than an analysis that employs SSIM. While both SSIM and an image difference function may both be used for generating the image frame quality data, the following description is provided using SSIM as the primary method of image comparison. In some embodiments, other types of image comparison techniques may be used and implemented using statistical analysis.

The second processing routine 304 represents the processing that an image frame may be subject to being downsampled and encoded for streaming and then decoded and upsampled for viewing on a recipient device. This second processing routine 304 processes the image frame 308 at the input using, in order, a downsampling step 316, an encoding step 318, a decoding step 320, and an upsampling step 322. The downsampling step 316 downsamples the image frame 308 to a target picture resolution. When generating image frame quality data, the target picture resolution used in each of the processing routines 302, 304, 306 is the same. The encoding step 318 encodes the output of the downsampling step 316 to a target bitrate, the decoding step 320 decodes the output of the encoding step 318, and the upsampling step 322 upsamples the output of the decoding step 320. The result of the second processing routine 304 is a second processed image frame (labeled IF_{B}) 324. From this second processing routine 304, the image frame 308 and the second processed image frame 324 may be compared for overall similarities or differences using the same image comparison technique used for the first processing routine 302.

The third processing routine 306 represents the processing that an image frame may be subject to being encoded for streaming, then decoded, followed by downsampling and then upsampling for viewing on a recipient device. The third processing routine 306 also represents the processing that an image frame may be subjected to when encoded (without resampling) for streaming and then decoded for viewing on a recipient device. This third processing routine 306 processes the image frame 308 at the input using, in order, an encoding step 326, a decoding step 328, a downsampling step 330, and an upsampling step 332. The encoding step 326 encodes the image frame 308 to a target bitrate, and the decoding step 328 decodes the output of the encoding step 326. The downsampling step 330 downsamples the output of the decoding step 328 to a target picture resolution, and the upsampling step 332 upsamples the output of the downsampling step 330. The result of the third processing routine 306 is a third processed image frame (labeled IF_{C}) 334 and a fourth processed image frame (labeled IF_{D}) 336. From this third processing routine 306, the image frame 308 may be compared with each of the third processed image frame 334 and the fourth processed image frame 336 for overall similarities or differences using the same image comparison technique used for the first processing routine 302.

Using the processing routines 302, 304, 306, image frame quality data may be generated for each encoded and streamed image frame 112 in the first video segment 104 of FIG. 1. In particular, the image frame quality data for an encoded and streamed image frame 112 may include a statistical analysis based on a comparison of the similarities between the input image frame IF₀ and each of the first processed image frame IF_{A}, the third processed image frame IF_{C}, and the fourth processed image frame IF_{D}, along with a comparison of the similarities between the third processed image frame IF_{C} and the fourth processed image frame IF_{D}, in order to calculate the similarities between the input image frame IF₀ and the second processed image frame IF_{B}. Then, using the image frame quality data for an encoded and streamed image frame, an estimate of the similarities between the input image frame IF₀ for the subsequent image frame and the second processed image frame IF_{B} for the subsequent image frame may be statistically generated.

As indicated above, SSIM may be used to compare each input image frame IF₀ with each respective processed image frame IF_{A}, IF_{C}, IF_{D}. for one or more of the encoded and streamed image frames 112 of FIG. 1. In addition, SSIM may also be used to compare the processed image frame IF_{C} with the processed image frame IF_{D}. The relationships for these various comparisons may be expressed as follows:

$${S}_{A} = SSIM ( {IF}_{0} , {IF}_{A} )$$

$${S}_{B} = SSIM ( {IF}_{0} , {IF}_{B} )$$

$${S}_{C} = SSIM ( {IF}_{0} , {IF}_{C} )$$

$${S}_{D} = SSIM ( {IF}_{0} , {IF}_{D} )$$

$${S}_{E} = SSIM ( {IF}_{D} , {IF}_{c} )$$

where SA represents a comparison of the similarities between the input image frame IF₀ and the first processed image frame IF_{A}, S_{B} represents a comparison of the similarities between the input image frame IF₀ and the second processed image frame IF_{B}, S_{C} represents a comparison of the similarities between the input image frame IF₀ and the third processed image frame IF_{C}, S_{D} represents a comparison of the similarities between the input image frame IF₀ and the fourth processed image frame IF_{D}, and S_{E} represents a comparison of the similarities between the third processed image frame IF_{C} and the fourth processed image frame IF_{D}. Using these comparisons, S_{B} may be determined from the following:

$${S}_{B} = {S}_{A} * ( {S}_{D} * α + \frac{{S}_{C}}{{S}_{E}} * β ) * {e}^{γ ( 1 - σ )} ,$$

where α+β=1.0, and where α, β, and γ are scalar parameters that may be optimized through regression or formula fitting, σ is a picture scaling or downsampling factor in the range of 0 to 1.0, where 1.0 represents the original resolution or no resolution reduction.

In some embodiments, S_{B} may be approximated by:

$${S}_{B} = {S}_{A} * \frac{( {S}_{D} + \frac{{S}_{C}}{{S}_{E}} )}{2} * {e}^{a * QP + b} ,$$

where a and b are scalar parameters that may be derived through regression or formula fitting, QP is estimated for the encoding compression. For both the calculation and the estimation of S_{B} above, estimates of S_{B} and S_{D} for each representative option (114, 116 of FIG. 1) associated with the subsequent image frame may obtained using SSIM to determine the difference between the subsequent image frame and the processed image frame IF_{A}. With S_{B} and S_{D} estimated, the streaming server may statistically analyze the pooled image frame quality data and select the picture resolution for the subsequent image frame based on which of S_{B} and S_{D} the statistical analysis indicates is closer to unity, which is an indication of the quality of the streamed video when viewed on the recipient device.

FIG. 4 illustrates an exemplary machine learning model 400 that may be used as part of processes for dynamically adjusting picture resolution in streaming video. This model 400 is configured as a multiple layer perceptron (MLP) model that receives at the input 402 the output from an image similarity comparison (e.g., SSIM) or an image difference comparison (e.g., the diff function). As shown, the model 400 receives at the input 402 the output from the diff function for each encoded and streamed image frame and for the subsequent image frame. With respect to each encoded and streamed image frame, the model 400 receives an evaluation of the differences between (with reference to FIG. 3) the input image frame IF₀ and each of the first processed image frame IF_{A}, the third processed image frame IF_{C}, and the fourth processed image frame IF_{D}, along with an evaluation of the difference between the third processed image frame IF_{C} and the fourth processed image frame IF_{D}. With respect to the subsequent image frame, the model 400 receives an evaluation of the differences between the input image frame IF₀ and the processed image frame IF_{A}. Following training, the model 400 returns, at the output 504, estimates for differences between the input image frame IF₀ for the subsequent image frame and the second processed image frame IF_{B}, and the fourth processed image frame IF_{D}. The streaming server determines the picture resolution for the subsequent image frame based on these outputs from the model 400. If the difference between the input image frame IF₀ for the subsequent image frame and the second processed image frame IF_{B} is greater than the difference between the input image frame IF₀ for the subsequent image frame and the fourth processed image frame IF_{D}, then the streaming server resamples and encodes the subsequent image frame to a lower picture resolution. If the difference between the input image frame IF₀ for the subsequent image frame and the second processed image frame IF_{B} is less than the difference between the input image frame IF₀ for the subsequent image frame and the fourth processed image frame IF_{D}, then the streaming server encodes the subsequent image frame without resampling, leaving the encoded image frame at the original picture resolution.

FIG. 5 illustrates an exemplary machine learning model 500 that may be used as part of processes for dynamically adjusting picture resolution in streaming video. This model 500 is configured as a recurrent neural network (RNN) model that receives at the input 502 the output from an image similarity comparison (e.g., SSIM) or an image difference comparison (e.g., the diff function). As shown, the model 500 receives output from the diff function for each encoded and streamed image frame and for the subsequent image frame as sequential. With respect to each encoded and streamed image frame, the model 500 sequentially receives an evaluation of the differences between (with reference to FIG. 3) the input image frame IF₀ and each of the first processed image frame IF_{A}, the third processed image frame IF_{C}, and the fourth processed image frame IF_{D}, along with an evaluation of the difference between the third processed image frame IF_{C} and the fourth processed image frame IF_{D}. With respect to the subsequent image frame, the model 500 receives an evaluation of the differences between the input image frame IF₀ and the processed image frame IF_{A}. Following training, the model 500 provides, at the output 504, estimates for differences between the input image frame IF₀ for the subsequent image frame and the second processed image frame IF_{B}, and the fourth processed image frame IF_{D}. The streaming server determines the picture resolution for the subsequent image frame based on these outputs from the model 500. If the difference between the input image frame IF₀ for the subsequent image frame and the second processed image frame IF_{B} is greater than the difference between the input image frame IF₀ for the subsequent image frame and the fourth processed image frame IF_{D}, then the streaming server resamples and encodes the subsequent image frame to a lower picture resolution. Otherwise, the streaming server encodes the subsequent image frame without resampling, leaving the encoded image frame at the original picture resolution.

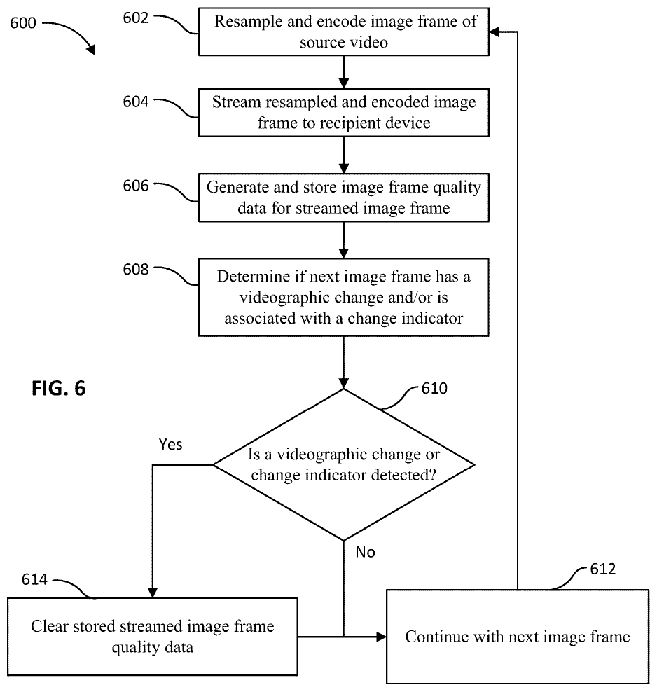

FIG. 6 is a flowchart illustrating the steps of an exemplary process 600 for resetting image frame quality data for encoded and streamed image frames in response to a change associated with the source video. The process 600 may be implemented on systems that are used for streaming video as discussed herein. One or more actions of the process 600 may be incorporated into or combined with one or more actions of any other process or embodiment described herein. For purposes of clarity, this process 600 is described in the context of being implemented on the streaming server 802 shown in FIG. 8. Also, any of the recipient devices 804, 806, 808 may perform the actions of the process 600 when operated to stream video to another device. In addition, one or more steps of the process 600 may be executed using distributed computing techniques, such that steps of the process 600 may be executed by control circuitry incorporated into other servers, cloud services, and/or other computing devices.

The process 600 may be executed at any point while streaming a video is in progress. In some embodiments, the process 600 may be implemented in parallel with the process 200 of FIG. 2, as several of the steps in both processes 200, 600 may be substantially similar. For purposes of clarity, the process 600 begins at step 602, in which the subsequent image frame of the source video is resampled and encoded based on the bitrate encoding and picture resolution determined to be appropriate for the first video segment (see FIG. 2, step 206). At step 604, the resampled and encoded image frame is streamed to the recipient device. At step 606 image frame quality data for the image frame last streamed at step 604 is generated and stored by the streaming server.

At step 608, the streaming server determines if the subsequent image frame in the source video has a videographic change, as compared to the previous image frame, and/or is associated with a change indicator. In some embodiments, step 608 may occur continuously throughout the encoding and streaming steps of process 600. A videographic change may be any change in the source video which has the potential to impact the quality of the streamed video when displayed on the recipient device. One type of videographic change that may impact the display quality of the streamed video is a change in scene from one with limited amounts of change (e.g., a news program with news anchors sitting and talking with much of the picture, aside from the talking anchors, remaining substantially static) to a scene with significant amounts of change (e.g., the sports news section of a news program showing clips of sporting events including substantial amounts of fast movement). In some videos, such a change may occur without an obvious scene change, such as when a video depicts a street that is empty of moving cars and suddenly numerous cars approach and pass by the camera quickly. In the face of such changes in the source video, the image frame quality data for the slow changing scene may not be sufficiently representative of image frames from the fast-changing scene to warrant comparison if a change in the estimated bandwidth is detected. In such a situation, the image frame quality data for the slow changing scene may skew potential dynamic adjustments to the picture resolution when compared to the image frame quality data for the fast-changing scene.

In some embodiments the scene change may be indicated by metadata associated with the source video. In the case of a news broadcast, metadata may be associated with the source video to indicate that a news clip video, e.g., a short video segment not recorded in the news studio, has been inserted into the source video of the news broadcast. Such metadata may be indicative of a scene change in the source video from a scene with little change (e.g., newscasters talking) to a fast-changing scene (e.g., a video segment from a sporting event). In some embodiments, the metadata may also indicate the nature of each scene in the metadata, and such indicators may be used to identify the nature of each scene and determine whether image frame quality data from a prior video scene would skew a potential dynamic adjustment when compared to the image frame quality data from image frames of the current scene.

At step 610, the process 600 determines if a videographic change or a change indicator has been detected. If no videographic change or change indicator is detected, at step 612 the process 600 continues with the subsequent image frame and returns to step 602 for resampling (as appropriate) and encoding the subsequent image frame. If a videographic change or a change indicator is detected, at step 614 the stored image frame quality data may be reset to remove image frame quality data for all image frames previously stored. In some embodiments, instead of resetting the stored image frame quality data, the process 600 may tag the existing image frame quality data so that it is not used for comparison with image frame quality data for the subsequent image frame and subsequent image frames. In such embodiments, the tagged image frame quality data may be used again if a subsequent scene from the source video once again includes slow changes that are similar in nature (e.g., a subsequent scene in the news cast returns to newscasters talking in the studio). After the prior image frame quality data has been reset or otherwise tagged to indicate it should not be used to compare with image frame quality data from the current video scene, at step 612 the process 600 continues with the subsequent image frame and returns to step 602 for resampling (as appropriate) and encoding the subsequent image frame.

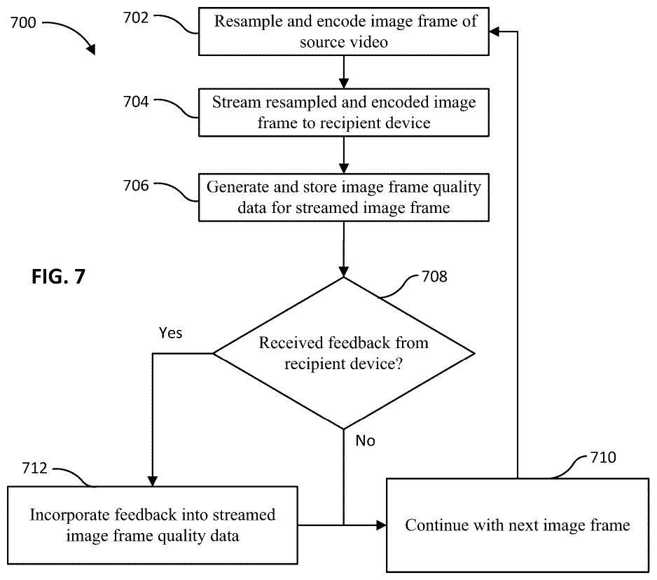

FIG. 7 is a flowchart illustrating the steps of an exemplary process 700 for incorporating feedback from a recipient device into the image frame quality data for encoded and streamed image frames (e.g., image frame quality data 120 of FIG. 1). The process 700 may be implemented on systems that are used for streaming video as discussed herein. One or more actions of the process 700 may be incorporated into or combined with one or more actions of any other process or embodiment described herein. For purposes of clarity, this process 700 is described in the context of being implemented on the streaming server 802 shown in FIG. 8. Also, any of the recipient devices 804, 806, 808 may perform the actions of process 700 when operated to stream video to another device. In addition, one or more steps of the process 700 may be executed using distributed computing techniques, such that steps of the process 700 may be executed by control circuitry incorporated into other servers, cloud services, and/or other computing devices.

The process 700 may be executed at any point while streaming a video is in progress. In some embodiments, the process 700 may be implemented in parallel with the process 200 of FIG. 2, as several of the steps in both processes 200, 700 may be substantially similar. For purposes of clarity, the process 700 begins at step 702, in which the subsequent image frame of the source video is resampled and encoded based on the bitrate encoding and picture resolution determined to be appropriate for the first video segment (see FIG. 2, step 206). At step 704, the resampled and encoded image frame is streamed to the recipient device. At step 706 image frame quality data for the image frame last streamed at step 704 is generated and stored by the streaming server.

At step 708, the process 700 determines if feedback relating to the quality of the streamed video has been received from a recipient device. If no feedback has been received, at step 710 the process 700 continues with the subsequent image frame and returns to step 702 for resampling and encoding the subsequent image frame. If feedback has been received, at step 712 the received feedback may be incorporated into the image frame quality data for the image frames that have been streamed prior to receiving the feedback. In some embodiments, the feedback received from recipient devices may be used as reinforcement learning for machine learning models used to compare the image frame quality data from previously encoded and streamed image frames with the image frame quality data from the subsequent image frame. In some embodiments the feedback recipient devices may be used to add or change weighting factors to statistical analysis models used to compare the image frame quality data from previously encoded and streamed image frames with the image frame quality data from the subsequent image frame. After processing the feedback, at step 710 the process 700 continues with the subsequent image frame and returns to step 702 for resampling and encoding the subsequent image frame.

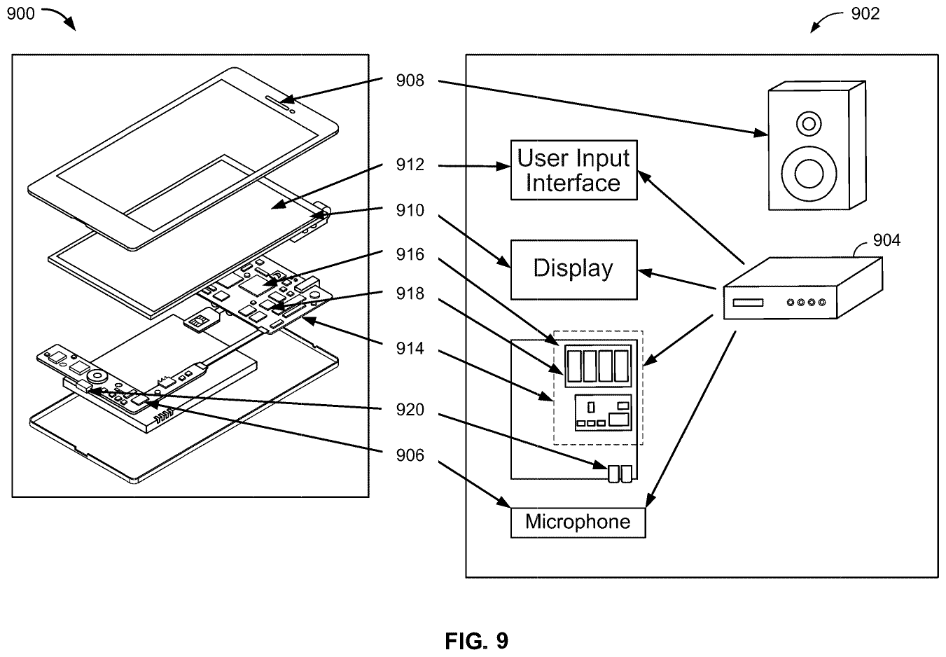

FIGS. 8-9 illustrate exemplary devices, systems, servers, and related hardware for streaming video, in accordance with some embodiments of the present disclosure. FIG. 8 is a diagram of an illustrative streaming system 800, in accordance with some embodiments of the disclosure. In this streaming system 800, a streaming server 802 and recipient devices 804, 806, 808 are communicably coupled to a communication network 810. The recipient devices 804, 806 808 shown are intended to be non-limiting exemplary devices, and many other types of devices may be used as recipient devices (e.g., laptop computers, tablet computers, virtual reality head-mounted displays, and projection systems, among others. As shown, the streaming system 800 also includes a media content source 812 and cloud services 814 communicably coupled to the communication network 810. The streaming system 800 may also include additional streaming servers, streaming devices, media sources, cloud services, and/or recipient devices communicably coupled to a communication network 810. In some embodiments, a recipient device may function as a streaming server to stream video to one or more other recipient devices coupled to the communication network 810. Similarly, in some embodiments, a cloud service may function as a streaming server to stream video to one or more of the recipient devices. In some embodiments, cloud services may provide processing, sharing, storage, and/or distribution services to the streaming server 802 and/or any of the recipient devices 804, 806, 808. In some embodiments, the video streaming processes described herein may be executed at the control circuitry 818 of the streaming server 802 and/or control circuitry of other servers connected to the communication network 810 and/or by control circuitry of cloud services connected to the communication network 810.

As used herein, the terms “cloud”, “cloud services”, and other related terms refer to a cloud computing environment in which various types of computing services may perform functions as part of a distributed computing system in combination with the control circuitry of another computing device, such as the streaming server 802 or any of the recipient devices 804, 806, 808. The cloud computing environment may provide computing services such as database services, virtual computing services, storage services, services for generating video, services for encoding/decoding video, and/or services for processing, analyzing, or parsing data (e.g., using algorithms, which may include machine learning algorithms) by a collection of network-accessible computing and storage resources. For example, the streaming server 802 may utilize machine learning algorithms to analyze image frame quality data as part of the process of dynamically adjusting picture resolution.

The communication network 810 may be one or more networks including the Internet, a mobile phone network, mobile voice or data network (e.g., a 4G or LTE network), cable network, public switched telephone network, or other types of communication network or combinations of communication networks. Paths (e.g., depicted as arrows connecting the respective devices to the communication network 810) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications between the streaming server 802 and the recipient devices 804, 806, 808 may be provided by one or more of these communications paths, thereby forming a network connection, but are shown as a single path in FIG. 8 to avoid overcomplicating the drawing.

Although communications paths are not drawn between recipient devices 804, 806, 808, the recipient devices 804, 806, 808 may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communications via wired or wireless paths. The recipient devices may also communicate with each other directly through an indirect path via the communication network 810.

As shown, the streaming server 802 includes a database 816, which may be used to store data associated with streaming videos. In some embodiments, the database 816 may be used to manage, organize, and/or store source videos that may be streamed by the streaming server 802. In such embodiments, source videos may be maintained at or otherwise associated with the streaming server 802, and/or at the storage 820, and/or at any other storage and/or at any other device having storage communicably coupled to the database 816 via the communication network 810. In some embodiments, the media content source 812 and the streaming server 802 may be integrated into one video source device.

Communications with the media content source 812 and the server 802 may be exchanged over one or more communications paths but are shown as a single path in FIG. 8 to avoid overcomplicating the drawing. Also, additional media content sources and/or additional streaming servers may be incorporated into the streaming system 800, but only one of each is shown in FIG. 8 to avoid overcomplicating the drawing.

The streaming server 802 includes control circuitry 818, a storage 820 (e.g., RAM, ROM, Hard Disk, Removable Disk, etc.), and an input/output (I/O) path 822. The I/O path 822 may provide device information, or other data, over a local area network (LAN) or wide area network (WAN), and/or other content and data to the control circuitry 818, which includes processing circuitry, and to the storage 820. The control circuitry 818 may be used to send and receive commands, requests, content, and other suitable data using the I/O path 812, which may include I/O circuitry. The control circuitry 818 may be instructed to perform all or any part of the functions discussed herein. The I/O path 822 may connect the control circuitry 804 (specifically, the processing circuitry) to one or more communications paths for communications with the communication network 810 and other servers, services, and devices.

The control circuitry 818 may include video encoding circuitry, such as one or more MPEG-2 encoders or any other encoding circuitry suitable for processing and encoding source video (e.g., over-the-air video, analog video, and/or digital video to MPEG encoded video for video streaming). The control circuitry 818 may also include video decoding circuitry, such as one or more MPEG-2 decoders or any other circuitry suitable for decoding and processing encoded video. The control circuitry 818 may also include scaler circuitry for upsampling and/or downsampling video into the preferred picture resolution format of a recipient device. The control circuitry 818 may also include analog-to-digital converter circuitry and digital-to-analog converter circuitry for converting between digital and analog video signals. The encoding circuitry 818 may be used by the streaming server to process, encode, decode, resample, and/or perform conversions of video as part of performing the processes and/or functions described herein in connection with FIGS. 1-7. The encoding circuitry described herein, including, for example, video generating, encoding, decoding, encrypting, decrypting, scaler, and analog/digital circuitry, may be implemented using software running on one or more general purpose or specialized processors. In some embodiments, the video encoding circuitry and/or the video decoding circuitry may be performed by other network-accessible systems and/or services (e.g., the media content source 812 and cloud services 814, among others).

The control circuitry 818 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, the control circuitry 818 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 818 executes instructions for an emulation system application stored in memory (e.g., the storage 820). Memory may be an electronic storage device provided as storage 820 that is part of the streaming server 802 In some embodiments, memory may be incorporated as part of the control circuitry 818.

The streaming server 802 may retrieve source video from storage 820, the database 816, or the media content source 812, process the source video as is described in detail herein, and stream the processed source video to one or more of the recipient devices 804, 806, 808. The media content source 812 may include one or more types of content distribution equipment including a television distribution facility, cable system headend, satellite distribution facility, programming sources, intermediate distribution facilities and/or servers, Internet providers, on-demand media servers, and other content providers. The media content source 812 may be the originator of content (e.g., a television broadcaster, a Webcast provider, etc.) or may not be the originator of content (e.g., an on-demand content provider, an Internet provider of content of broadcast programs for downloading, etc.). The Media content source 812 may include cable sources, satellite providers, on-demand providers, Internet providers, over-the-top content providers, or other providers of content. The media content source 812 may also include a remote media server used to store different types of content (including video content selected by a user), in a location remote from any of the recipient devices 804, 806, 808. The media content source 812 may also provide metadata that can be used to provide information about the media content (e.g., original picture resolution, color information, scene information, segment information, and the like).

The recipient devices 804, 806, 808 may operate in a cloud computing environment to access cloud services. In a cloud computing environment, various types of computing services for content processing, sharing, storage, or distribution (e.g., video sharing sites or social networking sites) are provided by a collection of network-accessible computing and storage resources. For example, the cloud can include a collection of server computing devices (such as, e.g., server 802), which may be located centrally or at distributed locations, that provide cloud-based services to various types of users and devices connected via a network such as the Internet via communication network 806. In such embodiments, recipient devices 804, 806, 808 may operate in a peer-to-peer manner without communicating with a central server, and in such an environment, the recipient devices 804, 806, 808 may stream video one another. Such video streaming between recipient devices 804, 806, 808 may include one-way video streaming (e.g., a video streamed from one of the recipient devices 804, 806, 808 to another of the recipient devices 804, 806, 808). Such video streaming may also include two- or multi-way video streaming (e.g., video conferencing between two or more of the recipient devices 804, 806, 808).

FIG. 9 shows generalized embodiments of illustrative recipient devices 900 and 902. For example, recipient device 900 may be a smartphone device. In another example, the recipient device 902 may be a smart television. In some embodiments, the recipient device 902 may be a set-top box 904 that is communicatively connected to a microphone 906, a speaker 908, and a display 910. In some embodiments, the display 910 may be a television display or a computer display. In some embodiments, the set-top box 904 may include a user input interface 912. In some embodiments, the user input interface 912 may be incorporated into a remote control device. The set-top box 904 may include one or more circuit boards. In some embodiments, the circuit boards may include control circuitry 914 (which may include integrated processing circuitry 916), and storage 918 (e.g., RAM, ROM, Hard Disk, Removable Disk, etc.). In some embodiments, the storage 918 may be integrated as part of the control circuitry 914. In some embodiments, the circuit boards may include an input/output (I/O) path 920. Some exemplary implementations of recipient devices are discussed above in connection with FIG. 8. Each of the recipient devices 900, 902 may receive streaming video via the I/O path 920. The I/O path 920 may provide streaming video (e.g., broadcast video, on-demand video, Internet video, video available over a local area network (LAN) or wide area network (WAN), video conferencing videos, and/or other types of video content) and data to the control circuitry 914. The control circuitry 914 may be used to send and receive commands, requests, streaming video, and other data using the I/O path 920, which may include I/O circuitry. The I/O path 920 may connect the control circuitry 914 (and specifically the processing circuitry 916) to one or more communications paths. I/O functions may be provided by one or more of these communications paths but are shown as a single path in FIG. 9 to avoid overcomplicating the drawing.

The control circuitry 914 may include any suitable processing circuitry such as processing circuitry 916. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 914 executes instructions for a media application stored in memory (i.e., storage 918). Specifically, the control circuitry 914 may be instructed by the media application to perform all or any part of the functions discussed herein. In some implementations, any action performed by control circuitry 914 may be based on instructions received from the media application.

In client/server-based embodiments, control circuitry 914 may include communications circuitry suitable for communicating with a media application server or other networks or servers. The instructions for carrying out the above-mentioned functionality may be stored on a server (which is described above in connection with FIG. 8. I/O circuitry may include a cable modem, an integrated services digital network (ISDN) modem, a digital subscriber line (DSL) modem, a telephone modem, Ethernet card, or a wireless modem for communications with other equipment, or any other I/O circuitry suitable for communications. Such communications may involve the Internet or any other suitable communication networks or paths (which is described in above in connection with FIG. 8). In addition, I/O circuitry may include circuitry that enables peer-to-peer communication of recipient devices, or communications of recipient devices in locations remote from each other (described in more detail below).

Memory may be an electronic storage device provided as storage 918 that is part of control circuitry 914. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 918 may be used to store various types of content described herein as well as media application data described above. Nonvolatile memory may also be used (e.g., to launch a boot-up routine and other instructions). Cloud-based storage, described above in relation to FIG. 8, may be used to supplement storage 918 or instead of storage 918.

The control circuitry 914 may include video decoding circuitry, such as one or more MPEG-2 decoders or any other circuitry suitable for decoding and processing received streaming video for display by the recipient device. The control circuitry 914 may also include video encoding circuitry, such as one or more MPEG-2 encoders or any other encoding circuitry suitable for converting source video (e.g., over-the-air video, analog video, and/or digital video to MPEG encoded video for video streaming). The control circuitry 914 may also include scaler circuitry for upsampling and downsampling video content into the preferred picture resolution format of a recipient device. The control circuitry 914 may also include digital-to-analog converter circuitry and analog-to-digital converter circuitry for converting between digital and analog video signals. The encoding circuitry may be used by recipient devices 900, 902 to receive, decode, resample, display, play, and/or record video content as well as to generate, encode, resample, and stream video content to other recipient devices. The encoding circuitry described herein, including, for example, video generating, encoding, decoding, encrypting, decrypting, scaler, and analog/digital circuitry, may be implemented using software running on one or more general purpose or specialized processors. If the storage 918 is provided as a separate device from the recipient device 900, the encoding circuitry may be associated with the storage 918.

A user may send instructions to the control circuitry 914 using user the input interface 912. The user input interface 912 may be any suitable user interface, such as a remote control, mouse, trackball, keypad, keyboard, touch screen, touchpad, stylus input, joystick, voice recognition interface, or other user input interfaces. The display 910 may be provided as a stand-alone device or integrated with other elements of each one of recipient devices 900, 902. For example, the display 910 may be a touchscreen or a touch-sensitive display. In such circumstances, the user input interface 912 may be integrated with or combined with the display 910. The display 910 may be one or more of a monitor, a television, a display for a mobile device, or any other type of display. A video card or graphics card may generate the output to the display 910. The video card may be any processing circuitry described above in relation to the control circuitry 914. The video card may be integrated with the control circuitry 914. Speakers 908 may be provided as integrated with other elements of each one of the recipient devices 900, 902. In some embodiments, the speakers 908 may be stand-alone units. The audio component of videos and other content displayed on the display 910 may be played through the speakers 908. In some embodiments, the audio may be distributed to a receiver (not shown), which processes and outputs the audio via speakers 908.

The media application for streaming and/or receiving streamed video may be implemented using any suitable architecture. For example, the media application may be a stand-alone application wholly implemented on each of the recipient devices 900, 902. In such an approach, instructions of the application may be stored locally (e.g., in the storage 918). The control circuitry 914 may retrieve instructions of the application from storage 918 and process the instructions to process received streamed video for display and/or to process source video for streaming. Based on the processed instructions, the control circuitry 914 may determine what action to perform when video is prepared for streaming and/or received and prepared for display. For example, in video conferencing applications, source video may be generated and processed (e.g., encoded and/or resampled) for streaming to another recipient device, and streamed video may be received and processed (e.g., decoded and/or resampled) for display.

In some embodiments, the media application may be a client/server-based application. Videos for use by a thick or thin client implemented on the recipient devices 900, 902 may be retrieved on-demand by issuing requests to a server remote from the recipient devices 900, 902. In one example of a client/server-based application, control circuitry 914 runs a web browser that interprets web pages provided by a remote server. For example, the remote server may store the instructions for the application in a storage device. The remote server may process the stored instructions using circuitry (e.g., control circuitry 914) to perform the operations discussed in connection with FIGS. 1-7.

Processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based on at least in part on a prior step.

1. A method of dynamically adjusting picture resolution in streaming video, the method comprising:
encoding, using control circuitry, first segment image frames in a first video segment of a source video at a first bitrate for streaming at a first picture resolution using a network connection to a recipient device, the network connection having a first estimated bandwidth, wherein the first bitrate and the first picture resolution are determined based on the first estimated bandwidth;
generating, using the control circuitry, first image frame quality data based on one or more of the first segment image frames in the first video segment;
detecting, using the control circuitry, a change in the network connection from the first estimated bandwidth to a second estimated bandwidth;
generating, using the control circuitry, second image frame quality data based on a subsequent image frame in a second video segment of the source video, the second video segment being subsequent to the first video segment within the source video;
determining a second bitrate and a second picture resolution for streaming using the network connection in response to the detected change in the network connection, the second bitrate based on the second estimated bandwidth, and the second picture resolution based on the determined second bitrate and a comparison of the first image frame quality data with the second image frame quality data; and
encoding, using the control circuitry, the second video segment at the second bitrate for streaming at the second picture resolution using the network connection to the recipient device.

2. The method of claim 1, further comprising:
encoding, using the control circuitry, the first segment image frames using single-pass encoding; and
encoding, using the control circuitry, the subsequent image frame using single-pass encoding.

3. The method of claim 1, further comprising, using the control circuitry, comparing the first image frame quality data with the second image frame quality data to generate a first picture quality estimate for the subsequent image frame encoded for streaming at the second picture resolution for comparison to a second picture quality estimate for the subsequent image frame encoded for streaming at the first picture resolution.

4. The method of claim 3, further comprising comparing, using the control circuitry, the first image frame quality data with the second image frame quality data using machine learning.

5. The method of claim 3, further comprising comparing, using the control circuitry, the first image frame quality data with the second image frame quality data using nonparametric statistical analysis.

6. The method of claim 1, further comprising generating, using the control circuitry, the first image frame quality data using a structural similarity index measure to compare each of the first segment image frames with an encoded version of each of the respective first segment image frames.

7. The method of claim 1, further comprising generating, using the control circuitry, the first image frame quality data by generating a resampled version of each of the first segment image frames.

8. The method of claim 7, further comprising generating, using the control circuitry, the first image frame quality data using a structural similarity index measure to compare each of the first segment image frames with the resampled version of each of the respective first segment image frames.

9. The method of claim 1, further comprising generating, using the control circuitry, the first image frame quality data by generating a resampled and encoded version of each of the first segment image frames.

10. The method of claim 9, further comprising generating, using the control circuitry, the first image frame quality data using a structural similarity index measure to compare each of the first segment image frames with the resampled and encoded version of each of the respective first segment image frames.

11. The method of claim 1, further comprising:
downsampling, using the control circuitry, the first segment image frames in the first video segment to generate downsampled image frames;
upsampling, using the control circuitry, the downsampled image frames to generate processed image frames; and
comparing, using the control circuitry, each processed image frame with each corresponding first segment image frame to generate the first image frame quality data.

12. The method of claim 1, further comprising:
decoding, using the control circuitry, the encoded first segment image frames in the first video segment to generate decoded image frames; and
comparing, using the control circuitry, each decoded image frame with each corresponding first segment frame to generate the first image frame quality data.

13. The method of claim 1, further comprising:
decoding, using the control circuitry, the encoded first segment image frames in the first video segment to generate decoded image frames;
downsampling, using the control circuitry, the decoded image frames to generate downsampled image frames;
upsampling, using the control circuitry, the downsampled image frames to generate processed image frames; and
comparing, using the control circuitry, each processed image frame with each corresponding first segment frame to generate the first image frame quality data.

14. The method of claim 1, further comprising:
downsampling, using the control circuitry, the subsequent image frame in the second video segment to generate a downsampled image frame;
upsampling, using the control circuitry, the downsampled image frame to generate a processed image frame; and
comparing, using the control circuitry, the processed image frame with the subsequent image frame to generate the second image frame quality data.

15. The method of claim 1, further comprising:
detecting a videographic change associated with the source video; and
modifying the first image frame quality data in response to the detected videographic change.

16. The method of claim 1, further comprising:
detecting a change indicator in video metadata associated with the source video; and
modifying the first image frame quality data in response to the detected change indicator.

17. The method of claim 1, further comprising:
receiving feedback data from the recipient device, the feedback relating to video quality; and
modifying the second image frame quality data in response to the feedback data.

18. A system for dynamically adjusting picture resolution in streaming video comprising:
input/output circuitry; and
control circuitry configured to:
encode first segment image frames in a first video segment of a source video at a first bitrate for streaming at a first picture resolution using a network connection to a recipient device, the network connection having a first estimated bandwidth, wherein the first bitrate and the first picture resolution are determined based on the first estimated bandwidth;
generate first image frame quality data based on one or more of the first segment image frames in the first video segment;
detect a change in the network connection from the first estimated bandwidth to a second estimated bandwidth;
generate second image frame quality data based on a subsequent image frame in a second video segment of the source video, the second video segment being subsequent to the first video segment within the source video;
determine a second bitrate and a second picture resolution for streaming using the network connection in response to the detected change in the network connection, the second bitrate based on the second estimated bandwidth, and the second picture resolution based on the determined second bitrate and a comparison of the first image frame quality data with the second image frame quality data; and
encode the second video segment at the second bitrate for streaming, using the input/output circuitry, at the second picture resolution using the network connection to the recipient device.

19. The system of claim 18, wherein the control circuitry is further configured to:
encode the first segment image frames using single-pass encoding; and
encode the subsequent image frame using single-pass encoding.

20. The system of claim 18, wherein the control circuitry is further configured to compare the first image frame quality data with the second image frame quality data to generate a first picture quality estimate for the subsequent image frame encoded for streaming at the second picture resolution for comparison to a second picture quality estimate for the subsequent image frame encoded for streaming at the first picture resolution.

21-51. (canceled)
